(19) United States
(12) Patent Application Publication
(10) Pub. No.: US 2017/0070787 A1
(43) Pub. Date: Mar. 9, 2017

(54) Liner notes/written material on TV screens, satellite feed to movie theaters, white tar roads & roofs, sorghun molasses with mealie meal

(71) Applicant: Michael Lewis Moravitz, Fairfax, VA (US)

(72) Inventor: Michael Lewis Moravitz, Fairfax, VA (US)

(21) Appl. No.: 14/121,538

(22) Filed: Jun. 4, 2014

(51) Int. Cl. H04N 21/61; H04N 21/414; H04N 21/4147; H04N 7/20

(52) U.S. Cl. CPC H04N 21/6143; H04N 7/20; H04N 21/41415; H04N 21/4147

(57) ABSTRACT

Liner Notes on MP3 Players, connecting to Video Systems through USB cable.

One of the problems with digital downloads of music onto MP3 players is the lack of documentation available to the consumer, particular for those interested in the artists or, especially in the classical music world, the composers and their works. Perhaps connecting MP3 players to home theater systems could allow liner notes to be shown on the TV screen or on an EReader. Perhaps a USB cable could be used for these purposes. Also, the material might be downloadable and printed out, but this might lead to too much clutter for those who prefer MP3 players. In fact, as in patent application Ser. No. 29/463,808 and Ser. No. 29/463,832, the music and video themselves might be downloaded to home theater and sound systems, along with the documents to be seen on a screen—or connected again to an EReader. This could avoid some issues of compatibility if the USB cable is standardized. Perhaps downloadable words—with sound—could be used more to help children read.

### SPECIFICATIONS

One of the problems with digital downloads of music onto MP3 players is the lack of documentation available to the consumer, particular for those interested in the artists or, especially in the classical music world, the composers and their works. Connecting MP3 players to memory in DVR and TiVo video storage systems, EReaders, and Laptops would get around this problem. A standard USB cable could be used for these purposes. Also, the material might be downloadable and printed out. Downloadable Liner Notes—with sound—could be used more to help children read, or to read along with the music.

1) Builds on patents for MP3 players such as the IPod;

2) USB cables;

3) Video storage device such as TiVo and DVR;

4) EReaders such as Nook and Kindle; and

5) Laptops.
